(19) United States
(12) Patent Application Publication
(10) Pub. No.: US 2025/0188904 A1
(43) Pub. Date: Jun. 12, 2025

(54) Offshore Vertical-Axis Wind Turbines With Integrated Drivetrains

(71) Applicants: National Technology & Engineering Solutions of Sandia, LLC, Albuquerque, NM (US); FPS Engineering & Technology, LLC, Sugar Land, TX (US)

(72) Inventors: Brandon L. Ennis, Albuquerque, NM (US); Edward Huang, Sugar Land, TX (US)

(21) Appl. No.: 18/970,019

(22) Filed: Dec. 5, 2024

Related U.S. Application Data
(60) Provisional application No. 63/606,650, filed on Dec. 6, 2023.

(51) Int. Cl. F03D 9/30; F03D 3/00; F03D 15/00

(52) U.S. Cl. CPC F03D 9/30; F03D 3/005; F03D 15/00; F05B 2220/30; F05B 2220/706

(57) ABSTRACT

Vertical-axis wind turbines (VAWTs) have inherent advantages over horizontal-axis wind turbines (HAWTs) resulting from the low center of gravity primarily caused by the low height of the drivetrain relative to the rotor. The low center of gravity is one of the main drivers for development of VAWTs for floating offshore wind energy generation, where the reduced center of gravity has positive system benefits by reducing the demands placed on the floating platform and its associated mass and cost. This advantage for VAWTs can be further enhanced by lowering the elevation of the drivetrain by housing it within the platform column.

### CROSS-REFERENCE TO RELATED APPLICATIONS

This application claims priority to provisional patent application U.S. Ser. No. 63/606,650, entitled “Offshore Vertical-Axis Wind Turbines With Integrated Drivetrains,” filed Dec. 6, 2023, the disclosure of which is incorporated herein by reference in its entirety.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD

The present disclosure is generally directed to offshore wind turbines, and more specifically directed to drivetrains integrated within floating platform columns.

### BACKGROUND OF THE INVENTION

Vertical-axis wind turbines (VAWTs) have inherent advantages over horizontal-axis wind turbines (HAWTs) resulting from the low center of gravity primarily caused by the low height of the drivetrain relative to the rotor. The low center of gravity is one of the main drivers for development of VAWTs for floating offshore wind energy generation, where the reduced center of gravity has positive system benefits by reducing the demands placed on the floating platform and its associated mass and cost.

What is needed are new VAWT floating offshore systems that further reduce the center of gravity of the systems to minimize the required mass and cost of the floating platform that supports the VAWT while maintaining stability with reduced dynamic loads in operation.

### SUMMARY OF THE INVENTION

The present disclosure is directed to vertical-axis wind turbine (VAWT) offshore systems that lower the system center of gravity by lowering the elevation of the drivetrain by housing the drivetrain within a platform column.

In an embodiment, the present disclosure is directed to wind turbine offshore floating platform system that includes a wind turbine; an offshore floating platform supporting the wind turbine, the offshore floating platform comprising one or three or more vertical columns; and a drivetrain integrated into the one or one of the three or more columns of the offshore floating platform.

In another embodiment, the present disclosure is directed to a floating platform that includes one or three or more vertical columns; and a drivetrain integrated into the one or one of the three or more columns.

An advantage of housing the VAWT drivetrain within the platform column is that the lower elevation of the drivetrain results in a reduction in the center of gravity.

Another advantage of the present disclosure is that the additional structure required to support the VAWT bearing and generator loads can be reduced through utilization of the existing column structure.

### BRIEF DESCRIPTION OF THE DRAWINGS

The application will become more fully understood from the following detailed description, taken in conjunction with the accompanying figures, wherein like reference numerals refer to like elements.

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention.

FIG. 1 is an illustration of a vertical-axis wind turbine (VAWT) floating offshore systems according to an embodiment of the disclosure.

FIG. 2 is a partial cutaway view of the offshore platform of FIG. 1.

FIG. 3 is an illustration of a vertical-axis wind turbine (VAWT) offshore systems according to another embodiment of the disclosure.

### DETAILED DESCRIPTION OF THE INVENTION

Before turning to the figures, which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

Vertical-axis wind turbines (VAWTs) have inherent advantages over horizontal-axis wind turbines (HAWTs) resulting from the low center of gravity primarily caused by the low height of the drivetrain relative to the rotor. For VAWTs, the drivetrain is typically located beneath the rotor instead of at the center of the rotor as for HAWTs. The low center of gravity is one of the main drivers for development of VAWTs for floating offshore wind energy generation. The reduced center of gravity has positive system benefits by reducing the demands placed on the floating platform and its associated mass and cost. This advantage for VAWTs can be further enhanced by lowering the elevation of the drivetrain further by housing it within the platform column.

The two main advantages of housing the VAWT drivetrain within the platform column are that (1) the lower elevation of the drivetrain results in a reduction in the center of gravity and (2) the additional structure required to support the VAWT bearing and generator loads can be reduced through utilization of the existing column structure with more minor increases in mass compared with adding additional structures above the top of the column to support the drivetrain.

In an embodiment, the drivetrain includes supports and bulkheads that transfer the bearing loads to the outer column structure. In an embodiment, the bearing spacing is limited by the design choice to locate the lower bearing above the mean water level. In other embodiments, the lower bearing may be below the mean water level. The bearing spacing can be increased, reducing the radial loads applied to the platform, by locating the lower bearing beneath the mean water level and/or locating the upper bearing above the top of column.

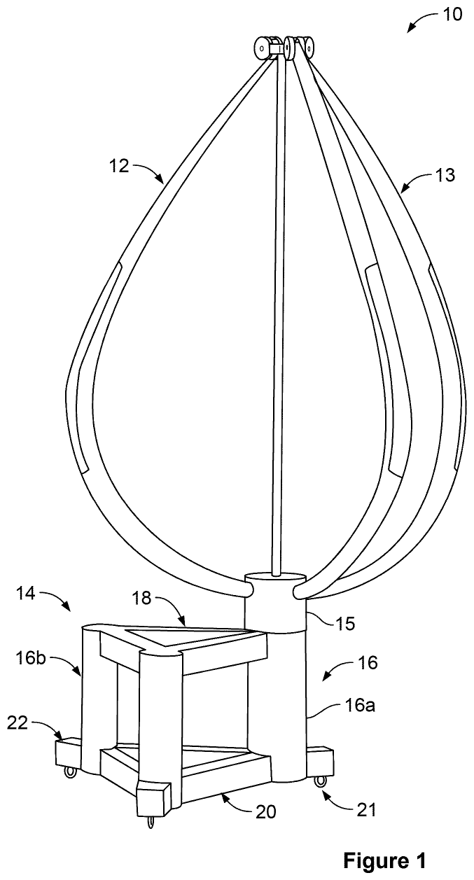

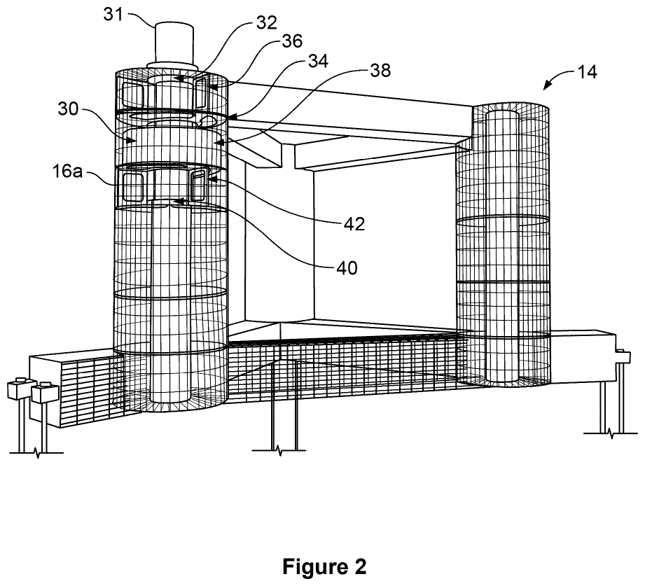

FIG. 1 illustrates a vertical-axis wind turbine (VAWT) offshore system 10 according to an embodiment of the disclosure. As can be seen in FIG. 1, the system 10 includes a VAWT 12 positioned upon a floating offshore platform 14. In this embodiment, the wind turbine 12 is a vertical axis wind turbine (VAWT) as is known in the art. For example, the VAWT may be that as disclosed in U.S. Pat. No. 11,421,650, issued Aug. 23, 2022, which is incorporated by reference in its entirety. In other embodiments, the wind turbine 12 may be but is not limited to a VAWT, horizontal axis wind turbine (HAWT), or airborn wind energy system as are known in the art. The VAWT includes turbine blades 13 connected to VAWT base 15 connected to a driveshaft 31 (FIG. 2).

The system 10 includes an overstructure over the platform 14 that has been removed for simplicity and that is well understood in the art. The overstructure includes components such as but not limited to decking, pumps, pipes, motors, generators, cables and other components as are known in the art for the support and operation of the wind turbine and hull. The overstructure also includes components to control and fill/empty ballast and are well known in the art and will not be discussed in any further detail herein. The columns, pontoons and optional leg extensions have internal hollow volume that may be partially filled with ballast (water) to stabilize the hull and platform.

As can further be seen in FIG. 1, the platform 14 includes three upright or vertical columns 16 connected by an upper column frame 18 and pontoons 20. The pontoons 20 have optional leg extensions 22 for locating tendons or mooring connection points and/or additional buoyancy. In this exemplary embodiment, the frame 18 includes three frame portions connected to the columns 16 and three portions connected to the columns 16. Attached to the leg extensions are mooring connections 21. In this exemplary embodiment, the three frame portions have the same length and design and are thus symmetrical. In other embodiments, the three frame portions may have different lengths and designs and thus be asymmetrical. In this exemplary embodiment, the three pontoons have the same length and design and are thus symmetrical. In other embodiments, the pontoons 20 may have different lengths and designs and be asymmetrical.

In this exemplary embodiment, the leg extensions 22 are symmetrical. In other embodiments, the leg extensions 22 may be asymmetrical in size and/or shape. For example, the leg extensions 22 may be of different lengths, wherein length is measured from the connection point to a column 16 to the opposing end of the leg extension 22.

In this exemplary embodiment, the mooring connections 21 are external to the leg extensions 22. In other embodiments, the mooring connections 21 may be internal and/or external to the leg extensions 22. In this exemplary embodiment, the mooring connections 21 are symmetrical. In other embodiments, the mooring connections 21 may be asymmetrical. For example, the one or more mooring connections may be placed at greater or lesser distance along the length of the leg extension.

In this exemplary embodiment, a primary column 16a supports the primary load of the turbine 12 as the central axis of the primary column 16a is directly aligned with the center of rotation of the turbine 12. In this exemplary embodiment, the columns have a circular diameter or cross-section with the primary column diameter greater than the two equal diameter secondary columns. The primary column 16a therefore having a larger internal volume. In other embodiments, the secondary column diameters may not be equal.

In other embodiments, the column cross-sections may be circular, oval, square, rectangular or other geometric shape. For non-circular columns, the columns have an equivalent diameter as is understood in the art. In this exemplary embodiment, the lower pontoons 20 are attached to leg extensions 22. For a non-circular column housing the drivetrain, the column may have additional bulkheads to transfer drivetrain loads to the column. In other embodiments, the platform 20 may or may not include leg extensions on one or all of the lower pontoons. In this exemplary embodiment, the leg extensions are equal. In other embodiments, the leg extensions size and shape may vary. In this exemplary embodiment, the positioning of the mooring connections is the same for all three leg extensions 22. In other embodiments, the positioning of the attachment points 21 may vary along the leg extension lengths. The primary and secondary columns 16a,16b provide stability to a platform hull and the associated platform to resist overturning resulting from weight and wind loading and/or angular roll/pitch displacement. As is understood in the art, ballast (typically in the form of water) can be used in portions of the columns 16, pontoons 20 and/or extensions 22 to lower the center of gravity and achieve the operational draft. Ballast volume in one or more of the columns, pontoons and extensions, as known in the art, may be modified as loading conditions change. As shown in this exemplary embodiment, the pontoons and extensions have the same structure, but in other embodiments, cross-sections, size and shape of these components may vary based on the structural demands or optimal buoyancy positioning.

In this exemplary embodiment, the primary column has a diameter that is 100% greater than the secondary columns. In other embodiments, the primary column may have a diameter or diameter equivalent up to 150% greater than the largest secondary column. In other embodiments, the primary column may have a diameter or diameter equivalent between 50% and 150% greater than the largest secondary column. In other embodiments, all three columns are of equal diameter and/or volume.

FIG. 2 illustrates a drivetrain 30 within a cutaway view of the primary column 16a. The drivetrain 30 converts mechanical energy from the turning driveshaft 31 connected to the VAWT into electrical energy. The cables and electrical components that transfer the electrical energy from the system 10 to a user have been omitted and are well understood in the art. As can be seen in FIG. 2, the drivetrain 30 includes an upper bearing 32, an upper bearing support ring 34, upper bearing supporting bulkheads 36, a drivetrain generator 38, a lower bearing 40 and lower bearing supporting bulkheads 42. In this exemplary embodiment, the bearing spacing is chosen to locate the lower bearing 40 above the mean water level. In other embodiments, all of the drivetrain and/or other portions of the drivetrain 30 may be located below the mean water level. For example, the driveshaft 31 can be extended such that the drivetrain generator 38 and/or lower bearing 40 and supporting bulkheads 42 can be lowered to be below the mean water level while still being housed in watertight regions of the column. In other embodiments, the drivetrain may include additional components and/or be of other configurations that include seals and other electrical component configurations.

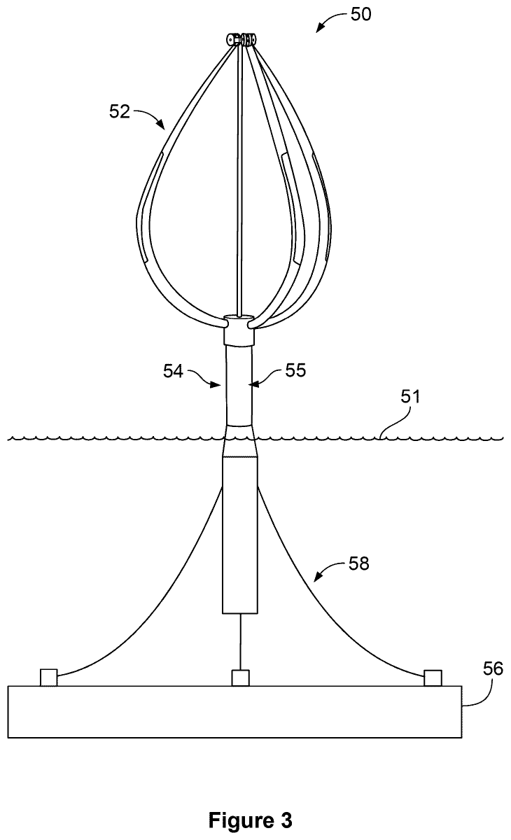

FIG. 3 illustrates a vertical-axis wind turbine (VAWT) offshore system 50 having a mean water level 51 according to another embodiment of the disclosure. As can be seen in FIG. 3, the system 50 includes a VAWT 52 positioned upon a single column offshore platform 54. In this embodiment, the platform 54 includes a drivetrain as shown in FIGS. 1 and 2. In other embodiments, portions of the drivetrain can be housed below the mean water level within the platform column.

The platform 54 includes a floor platform 56 attached to a column 55 by moorings 58. In other embodiments, the column may be directly attached to the seabed without a floor platform. As is understood in the art, the system 50 may include platforms and other support structures as understood in the art.

The invention being thus described, it will be obvious that the same may be varied in many ways. Such variations are not to be regarded as a departure from the spirit and scope of the invention, and all such modifications as would be obvious to one skilled in the art are intended to be included within the scope of the appended claims. It is intended that the scope of the invention be defined by the claims appended hereto. The entire disclosures of all references, applications, patents and publications cited above are hereby incorporated by reference.

In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A wind turbine floating offshore platform system, comprising:
a wind turbine;
an offshore floating platform supporting the wind turbine, the offshore floating platform comprising one or three or more vertical columns; and
a drivetrain integrated into the one or one of the three or more columns of the offshore floating platform.

2. The system of claim 1, wherein a portion of the drivetrain is located below a mean water line of the wind turbine offshore floating platform system.

3. The system of claim 1, wherein the drivetrain includes a lower bearing.

4. The system of claim 3, wherein the lower bearing is located below the mean water line.

5. The system of claim 3, wherein the lower bearing is located above the mean water line.

6. The system of claim 1, wherein the offshore floating platform includes three or more vertical columns connecting sections of an upper frame and lower pontoon sections.

7. The system of claim 1, wherein the center of gravity of the drivetrain is located within the column.

8. The system of claim 1, wherein the wind turbine is a vertical axis wind turbine.

9. The system of claim 1, wherein the drivetrain further comprises a driveshaft, an upper bearing, a generator and a lower bearing.

10. The system of claim 1, wherein drivetrain is located below the mean water line.

11. A floating offshore platform, comprising:
one or three or more vertical columns; and
a drivetrain integrated into the one or one of the three or more columns.

12. The platform of claim 11, wherein a portion of the drivetrain is located below a mean water line of the platform.

13. The platform of claim 11, wherein the drivetrain includes a lower bearing.

14. The platform of claim 13, wherein the lower bearing is located below the mean water line.

15. The platform of claim 13, wherein the lower bearing is located above the mean water line.

16. The platform of claim 11, wherein the offshore floating platform includes three or more vertical columns connecting sections of an upper frame and lower pontoon sections.

17. The platform of claim 11, wherein the center of gravity of the drivetrain is located within the column.

18. The platform of claim 11, wherein the wind turbine is a vertical axis wind turbine.

19. The platform of claim 11, wherein the drivetrain comprises a driveshaft, an upper bearing, a generator and a lower bearing.

20. The platform of claim 11, wherein drivetrain is located below the mean water line.
